(19) United States
(12) Patent Application Publication
(10) Pub. No.: US 2015/0253878 A1
(43) Pub. Date: Sep. 10, 2015

(54) ELECTRONIC DEVICE AND METHOD

(71) Applicant: Kabushiki Kaisha Toshiba, Tokyo (JP)

(72) Inventor: Yasuhiro Ookawara, Kunitachi Tokyo (JP)

(21) Appl. No.: 14/521,320

(22) Filed: Oct. 22, 2014

(30) Foreign Application Priority Data
Mar. 7, 2014 (JP) 2014-044746

(51) Int. Cl. G06F 3/0354; G06F 3/0488

(52) U.S. Cl. CPC G06F 3/03545; G06F 3/04883

(57) ABSTRACT

According to one embodiment, an electronic device includes a processing circuitry to display one or more first strokes input by handwriting on a screen, and to display input candidates searched by using the one or more first strokes after an input of the one or more first strokes. If a first candidate comprising second strokes and a second candidate comprising third strokes corresponding to a same character string are searched as input candidates by using the one or more first strokes, one of the first candidate and the second candidate is excluded from input candidates, and the other of the first candidate and the second candidate is displayed as an input candidate on the screen.

### CROSS-REFERENCE TO RELATED APPLICATIONS

This application is based upon and claims the benefit of priority from Japanese Patent Application No. 2014-044746, filed Mar. 7, 2014, the entire contents of which are incorporated herein by reference.

### FIELD

Embodiments described herein relate generally to a technique of inputting characters by handwriting.

### BACKGROUND

Various electronic devices, such as tablets, PDAs and smartphones, have recently been developed. To facilitate user's input operations, many electronic devices of this type are provided with a touch screen display and have a function for handwriting. This function enables users to create a document including not only text and images but also handwritten characters and figures.

There is a method of assisting user's input of a character string, such as a word, utilizing a history of character strings input so far.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the exterior appearance of an electronic device according to an embodiment.

FIG. 2 is a view showing examples of strokes handwritten on the touch screen display of the electronic device of the embodiment.

FIG. 3 is an exemplary view for explaining time-series data (stroke data) corresponding to the handwritten strokes of FIG. 2 and stored in a storage medium by the electronic device of the embodiment.

FIG. 4 is an exemplary block diagram showing the system configuration of the electronic device of the embodiment.

FIG. 5 is a view showing a display example of handwritten candidate character strings based on a halfway input handwritten character string.

FIG. 6 is a view showing a display example for explaining completion of the halfway input handwritten character string using a character string selected from the handwritten candidate character strings of FIG. 5.

FIG. 7 is a view showing an example of displaying first-stage handwritten candidate character strings based on the halfway input handwritten character string.

FIG. 8 is a view showing an example of displaying second-stage handwritten candidate character strings in accordance with the character string selected from the first-stage handwritten candidate character strings.

FIG. 9 is a view showing an example of completing the halfway input handwritten character string using a character string selected from the second-stage handwritten character strings of FIG. 8.

FIG. 10 is a view showing an example of completing the halfway input handwritten character string using a character string selected from the first-stage handwritten candidate character strings of FIG. 7.

FIG. 11 is a block diagram showing a function configuration example of a predicted-input utility program 202 executed by the electronic device of the embodiment.

FIG. 12 is a table showing a structure example of handwriting character string data used by the electronic device of the embodiment.

FIG. 13 is a table showing examples of handwriting character string candidates generated by the electronic device of the embodiment in the order of similarity degree.

FIG. 14 is a view showing another example of displaying first-stage handwritten candidate character strings by the electronic device of the embodiment, based on a halfway input handwritten character string.

FIG. 15 is a view showing an example of completing the halfway input handwritten character string using a character string selected from the first-stage handwritten candidate character strings of FIG. 14.

FIG. 16 is a view showing an example of displaying second-stage handwritten candidate character strings in accordance with an image selected from the first-stage handwritten candidate character strings of FIG. 14.

FIG. 17 is a view showing an example of completing the halfway input handwritten character string using a character string selected from the second-stage handwritten candidate character strings of FIG. 16.

FIG. 18 is a flowchart showing a procedure example of handwriting input processing executed by the electronic device of the embodiment.

FIG. 19 is a flowchart showing a procedure example of similarity degree calculation processing executed by the electronic device of the embodiment.

FIG. 20 is a flowchart showing a procedure example of predictive input processing executed by the electronic device of the embodiment.

FIG. 21 is a flowchart showing another procedure example of predictive input processing executed by the electronic device of the embodiment.

### DETAILED DESCRIPTION

Various embodiments will be described hereinafter with reference to the accompanying drawings. In general, according to one embodiment, an electronic device includes a processing circuitry to display one or more first strokes input by handwriting on a screen, and to display input candidates searched by using the one or more first strokes after an input of the one or more first strokes. If a first candidate comprising second strokes and a second candidate comprising third strokes corresponding to a same character string are searched as input candidates by using the one or more first strokes, one of the first candidate and the second candidate is excluded from input candidates, and the other of the first candidate and the second candidate is displayed as an input candidate on the screen.

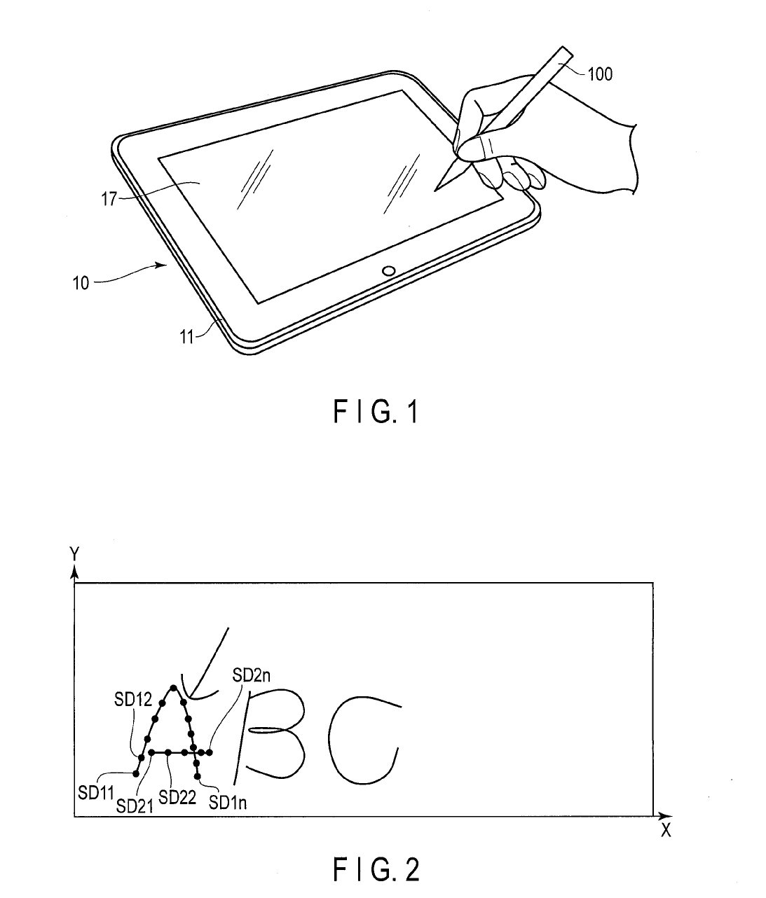

FIG. 1 is a perspective view showing the exterior appearance of an electronic device according to an embodiment. This electronic device is a stylus-based portable electronic device enabling a user to input data by handwriting using, for example, a stylus or a finger. The electronic device can be realized as a tablet computer, a notebook PC, a smartphone, a PDA, etc. Hereinafter, it is assumed that the electronic device is realized as a tablet computer 10. The tablet computer 10 is a portable electronic device also called a tablet or a slate computer, and includes a main unit 11 and a touch screen display 17 as shown in FIG. 1. The touch screen display 17 is attached to the main unit 11, superposed on the upper surface of the unit 11.

The main unit 11 has a thin box-shaped casing. The touch screen display 17 incorporates a flat panel display, and a sensor configured to detect the contact position of a stylus or a finger on the screen of the flat panel display. The flat panel display may be, for example, a liquid crystal display (LCD). As the sensor, a touch panel of an electrostatic capacitance type, a digitizer of an electromagnetic induction type, etc., may be used. In the description below, it is assumed that two types of sensors, i.e., the digitizer and the touch panel, are both incorporated in the touch screen display 17.

Each of the digitizer and the touch panel is provided to cover the screen of the flat panel display. The touch screen display 17 can detect not only a touch operation on the screen using a finger, but also a touch operation on the screen using a stylus 100. The stylus 100 is, for example, an electromagnetic induction stylus.

A user can perform a handwriting input operation of inputting a plurality of strokes on the screen display 17 by handwriting, using an external object (stylus 100 or finger). During the handwriting input operation, the locus of motion of the external object (stylus 100 or finger) on the screen, i.e., the locus (handwriting) of strokes handwritten by the handwriting input operation, is drawn in real time, whereby the locus of each stroke is displayed on the screen. The locus of motion of the external object while the external object is in contact with the screen corresponds to one stroke. A set of strokes, i.e., a set of loci (handwriting), forms a handwritten character or figure.

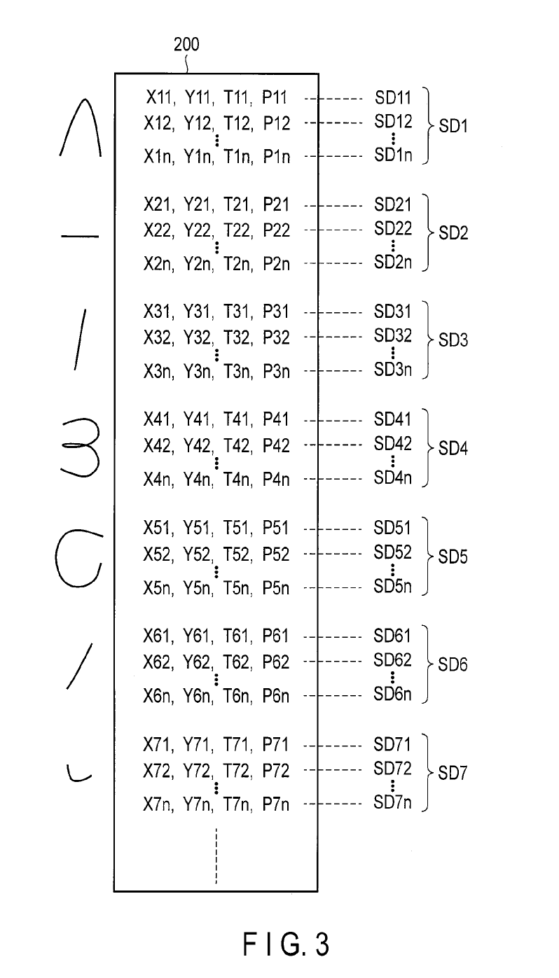

In the embodiment, such handwritten strokes (handwritten character or figure) are not stored as image data, but as time-series data indicative of a sequence of coordinates corresponding to the loci of strokes and the order relationship between the strokes. As will be described later in detail referring to FIG. 3, the time-series data substantially means a set of time-series stroke data items corresponding to respective strokes. Each stroke data item may be any type of data, if it can express a stroke permitted to be input by handwriting. For instance, it includes a coordinate data sequence (time-series coordinate pairs) corresponding to respective points on the locus of the stroke. The order of the stroke data items corresponds to the handwriting order of the strokes.

The tablet computer 10 can read any desired document data existing in the storage medium, and display on the screen a document corresponding to the document data, i.e., a handwritten document in which loci corresponding to the strokes indicated by the time-series data are traced.

Referring now to FIGS. 2 and 3, a description will be given of the relationship between strokes (handwritten characters, marks, figures, tables, etc.) handwritten by the user and time-series data. FIG. 2 shows an example of a document handwritten on the touch screen display 17 using, for example, the stylus 100.

In this document, on a once written character, figure or the like, another character, figure, etc., may well be handwritten. In FIG. 2, it is assumed that a handwritten character string of “ABC” was made by handwriting “A,” “B” and “C” in this order, and then adding a handwritten arrow just near the handwritten character “A.”

The handwritten character “A” is made by two strokes (loci of “Λ” and “—”) handwritten using, for example, the stylus 100, i.e., two loci. The locus of the stylus 100 in the form of “Λ,” which is initially handwritten, is sampled at, for example, regular intervals in a real-time manner. As a result, time-series coordinate data items SD11, SD12, . . . , SD1n corresponding to the “Λ” stroke are obtained. Similarly, the locus of the stylus 100 in the form of “—,” which is subsequently handwritten, is sampled, whereby time-series coordinate data items SD21, SD22, . . . , SD2n corresponding to the “—” stroke are obtained.

A handwritten character “B” is represented by two strokes handwritten using, for example, the stylus 100, i.e., two loci. A handwritten character “C” is represented by one stroke handwritten using, for example, the stylus 100, i.e., one locus. Further, a handwritten arrow is represented by two strokes handwritten using, for example, the stylus 100, i.e., two loci.

FIG. 3 shows time-series data 200 corresponding to the document shown in FIG. 2. The time-series data 200 includes a plurality of stroke data items SD1, SD2, . . . , SD7. In the time-series data 200, the stroke data items SD1, SD2, . . . , SD7 are arranged in a time-series manner in the order of handwriting.

In the time-series data 200, the leading two stroke data items SD1 and SD2 indicate the two strokes of the handwritten character “A.” The third and fourth stroke data items SD3 and SD4 indicate the two strokes of the handwritten character “B.” The fifth stroke data item SD5 indicates the one stroke of the handwritten character “C.” The sixth and seventh stroke data items SD6 and SD7 indicate the two strokes forming the handwritten arrow.

Each stroke data item includes a coordinate data sequence (time-series coordinate pairs) corresponding to one stroke, namely, includes pairs of coordinates corresponding to respective points on the locus of one stroke. In each stroke data item, pairs of coordinates are arranged in the order of handwriting of strokes. For instance, regarding the handwritten character “A,” the stroke data item SD1 includes a coordinate data sequence (time-series coordinate pairs) corresponding to respective points on the stroke locus in the form of “Λ” of “A”, i.e., n coordinate data items SD11, SD12, . . . , SD1n. Similarly, the stroke data item SD2 includes a coordinate data sequence corresponding to respective points on the locus of a stroke indicating “—” of the handwritten character “A,” i.e., n coordinate data items SD21, SD22, . . . , SD2n. The number of the coordinate data items may differ among different stroke data items.

Each coordinate data item indicates X- and Y-coordinates indicating the corresponding point on a locus. For instance, the coordinate data item SD11 indicates X-coordinate “X11” and Y-coordinate “Y11” corresponding to the initial point of the stroke “Λ.” The SD1n indicates X-coordinate “X1n” and Y-coordinate “Y1n” corresponding to the terminal point of the stroke “Λ.”

Further, each coordinate data item may include time-stamp data T indicative of the time point at which the corresponding point was handwritten. This time point may be either an absolute time (e.g., year, month, day, o'clock, minutes, seconds) or a relative time with respect to a certain time point. For instance, an absolute time (e.g., year, month, day, o'clock, minutes, seconds) at which a stroke was started to be written may be added as time-stamp data to a stroke data item, and a relative time indicating a difference from the absolute time may be added as time-stamp data T to each coordinate data item in the stroke data item. The use of the time-series data including the time-stamp data T for each coordinate data item enables the temporal relationship between strokes to be expressed more precisely.

Further, each coordinate data item may include pressure data P concerning pressure with which an external object (e.g., the stylus 100) touched the screen when the point indicated by the corresponding coordinates was handwritten.

As described above, in the embodiment, since a handwritten stroke is stored not as an image or a character recognition result, but as the time-series data 200 formed of a set of time-series stroke data items, handwritten characters or figures can be treated regardless of their languages. Thus, the structure of the time-series data 200 can be shared among various countries using different languages.

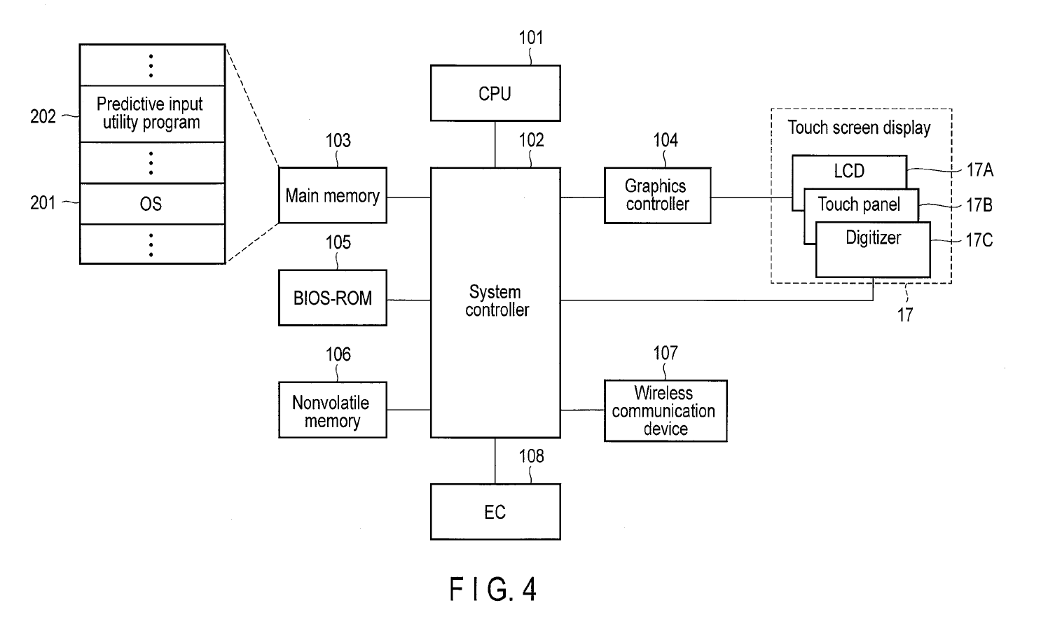

FIG. 4 shows the system configuration of the tablet computer 10.

As shown in FIG. 4, the tablet computer 10 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor for controlling the operations of various components in the computer 10. The CPU 101 executes various types of software loaded from the nonvolatile memory 106 onto the main memory 103. This software includes an operating system (OS) 201 and various application programs. The application programs include a predictive input utility program 202. The predictive input utility program 202 has a predictive input function (suggest function) of presenting candidates for a character string whose input is predicted, based on one or more handwritten strokes. Using this predictive input function, the predictive input utility program 202 realizes a search keyword suggest function, a completing function of completing a character string input to a document, etc.

The CPU 101 also executes a basic input output system (BIOS) stored in the BIOS-ROM 105. The BIOS is a program for hardware control.

The system controller 102 is a device that connects the CPU 101 to each module. The system controller 102 contains a memory controller for performing access control of the main memory 103. The system controller 102 also has a function of communicating with the graphics controller 104 via a serial bus of the PCI EXPRESS standard.

The graphics controller 104 is a display controller configured to control an LCD 17A used as the display monitor of the tablet computer 10. The display signals generated by the graphics controller 104 are sent to the LCD 17A. On the LCD 17A, a touch panel 17B and a digitizer 17C are disposed. The touch panel 17B is a pointing device of an electrostatic capacitance type configured to perform inputting on the screen of the LCD 17A. The contact position of a finger on the screen, the movement of the contact position on the screen, and the like, are detected by the touch panel 17B. The digitizer 17C is a pointing device of an electromagnetic induction type configured to perform inputting on the screen of the LCD 17A. The contact position of a stylus 100 on the screen, the movement of the contact position of the stylus on the screen, and the like, are detected by the digitizer 17C.

The wireless communication device 107 is configured to execute wireless communication, such as a wireless LAN or 3G mobile communication. The EC 108 is a one-chip microcomputer including an embedded controller for power management. The EC 108 has a function of turning on and off the tablet computer 10 in accordance with a user's operation of a power button.

As described above, the predictive input utility program 202 uses the predictive input function to realize the completing function of completing a character string input to a document, a suggest function of suggesting a search keyword, etc.

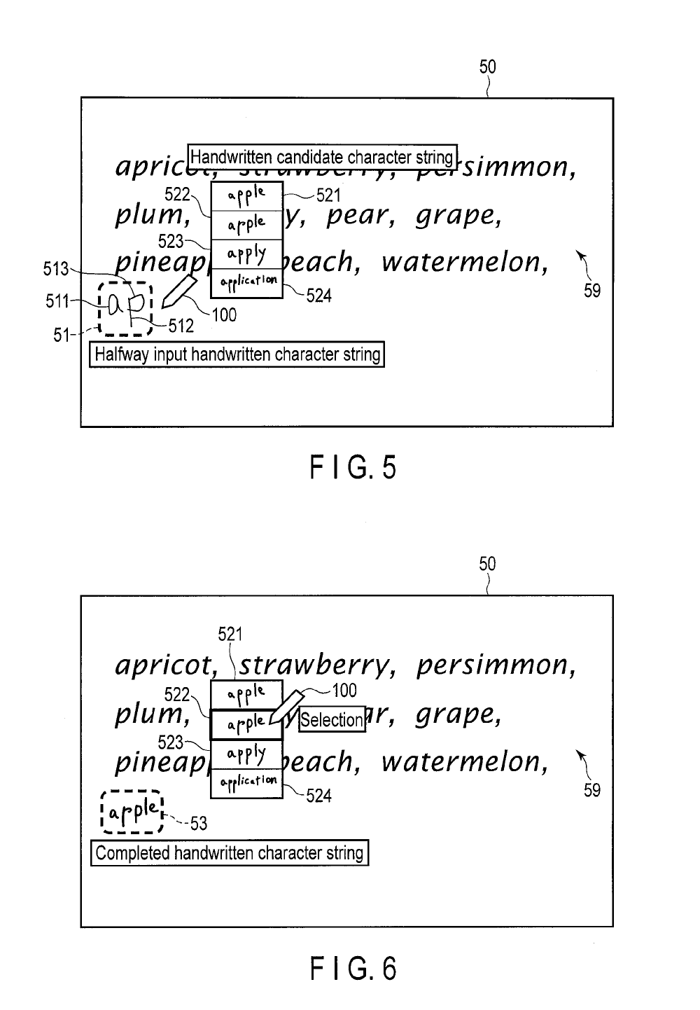

FIG. 5 shows a display example in which handwritten candidate character strings are displayed using the predictive input function on a screen image 50 in which a character is handwritten. It is assumed here that the user intend to input a word “apple” and has inputted a character string “ap” 51.

The screen image 50 displays (i) handwritten character strings 59 already input by the user, (ii) strokes 511, 512 and 513 constituting a character string “ap” 51 included in a halfway input character string, and (iii) handwritten candidate character strings “apple” 521, “apple” 522, “apply” 523 and “application” 524, based on the halfway handwritten “ap” 51 (strokes 511, 512 and 513). The handwritten candidate character strings 521 to 524 are, for example, candidate character strings extracted from character strings already written by the user or included in a handwritten document already created by the user, and similar to the halfway handwritten “ap” 51.

If a target character string to be input is included in the candidate character strings 521 to 524, the halfway handwritten “ap” 51 can be replaced with the corresponding candidate character string, e.g., “apple” 522, by selecting (pressing a button corresponding to) the candidate character string, as shown in FIG. 6. Thus, the character string “apple” desired to be input can be written to the handwritten document by halfway inputting the word “apple,” namely by inputting only “ap.”

The character strings already written by the user or the handwritten document already created by the user may include a plurality of handwritten character strings corresponding to the same character string (such as a word). For instance, a plurality of handwritten character strings “apple” may be included in a single handwritten document or in respective handwritten documents.

Because of this, as shown in the example of FIG. 5, the displayed handwritten candidate character strings “apple” 521, “apple” 522, “apply” 523 and “application” 524 may include candidates 521 and 522 (i.e., equivalent candidate character strings) corresponding to the same character string “apple.” Since, for example, the screen image 50 can display only a limited number (e.g., 4) of candidate character strings, the display of the equivalent candidate character strings 521 and 522 of “apple” may reduce the possibility of display of candidate character strings desired by the user.

In view of the above, in the embodiment, if a plurality of candidate character strings corresponding to a halfway input character string (one or more handwritten strokes) include a first candidate character string and a second candidate character string both corresponding to the same character string, one or more candidate character strings (first-stage candidate character strings) for inputting are displayed with one of the first and second candidate character strings excluded. Namely, the first-stage candidate character strings excluding one of the equivalent candidate character strings are displayed. If one of the first and second candidate character strings is excluded, second-stage candidate character strings including the candidate character string identical to the first or second candidate character string are displayed on the screen when the other of the first and second candidate character strings is selected. In other words, if the user has selected one candidate character string from the first-stage candidate character strings, and if there is a candidate character string having been excluded in the first stage because this equals the selected candidate character string, second-stage candidate character strings including the selected candidate character strings and the excluded candidate character string are displayed. The user selects a preferred candidate character string from the second-stage candidate character strings, whereby the halfway handwritten character string is replaced with the selected candidate character string.

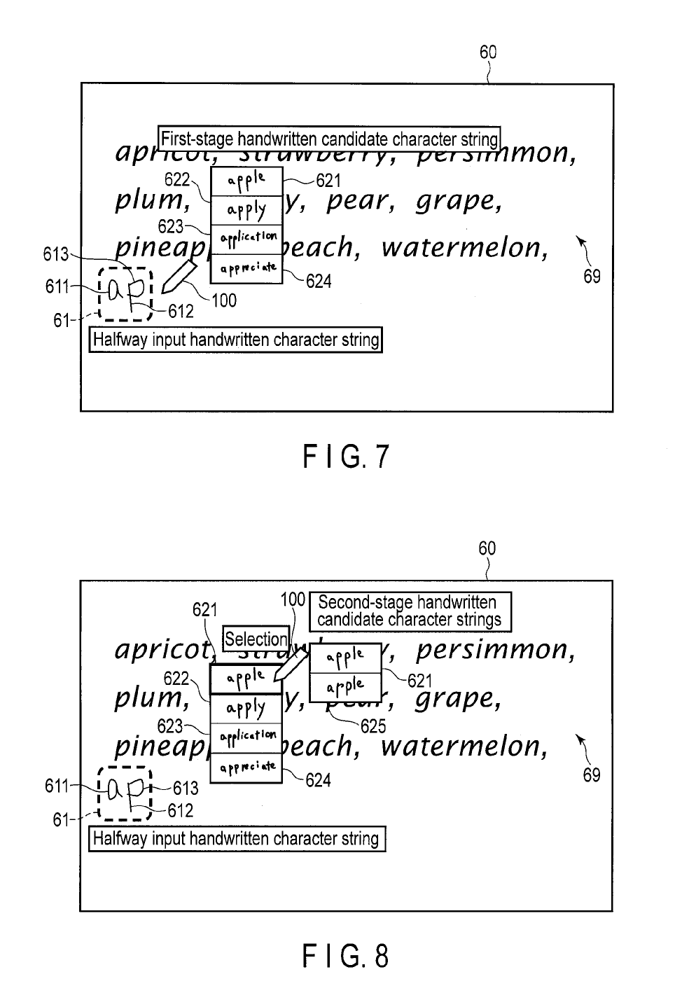

As shown in FIG. 7, a handwritten document screen image 60 displayed by the tablet computer 10 of the embodiment displays (i) handwritten character strings 69 already input by the user, and (ii) strokes 611, 612 and 613 forming a character string “ap” 61 included in a halfway input character string. The screen image 60 also displays first-stage handwritten candidate character strings “apple” 621, “apply” 622, “application” 623 and “appreciate” 624, based on the halfway handwritten “ap” 61 (strokes 611, 612 and 613). The first-stage handwritten candidate character strings 621 to 624 are obtained by, for example, extracting candidate character strings similar to the halfway handwritten “ap” 61 (strokes 611, 612 and 613) from character strings already written by the user or included in a handwritten document already created by the user, and then excluding the equivalent character string(s) from the extracted candidate character strings.

If the first-stage handwritten candidate character strings 621 to 624 include, as shown in FIG. 8, a character string “apple” to be input, the user selects a candidate character string “apple” 621 (presses a button corresponding to this candidate character string). Thus, the user can designate the display of second-stage handwritten candidate character strings 621 and 625. The second-stage candidate character strings 621 and 625 include the candidate character string “apple” 621 selected from the first-stage handwritten candidate character strings 621 to 624, and the candidate character string “apple” 625 excluded in the first stage because it equals the candidate character string “apple” 621, i.e., it is the same character string as the candidate character string “apple” 621. Although the candidate character strings 621 and 625 are both character strings of “apple,” they have different shapes (handwriting) depending upon whether, for example, they were handwritten in haste or in a courteous manner in, for example, character strings or documents previously handwritten by the user.

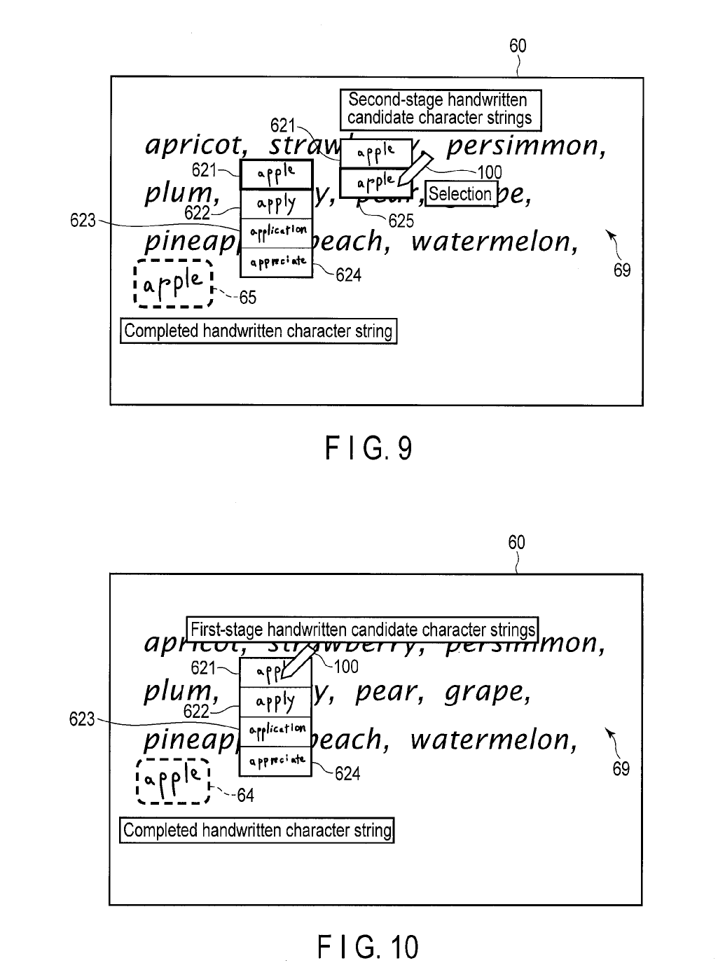

In light of the above, as shown in FIG. 9, the user selects a desired candidate character string 625 (e.g., a most beautiful handwritten candidate character string, a candidate character string suitable for a currently handwritten document, etc.) from the second-stage candidate character strings 621 and 625. As a result, the currently halfway handwritten character string “ap” 61 is replaced with the selected candidate character string 625, whereby a completed handwritten character string “apple” 65 is written to the handwritten document on the screen image 60. Thus, the user does not have to handwrite the entire character string “apple” in order to input a handwritten character string “apple” of desired handwriting to the handwritten document.

Further, as is shown in FIG. 10, if one candidate character string “apple” 621 is selected from the first-stage candidate character strings 621 to 624, and if no candidate character string is excluded in the first stage because it equals the candidate character string “apple” 621, the halfway handwritten character string “ap” 61 is directly replaced with the selected candidate character string 621 without displaying the second-stage candidate character strings.

As described above, the predictive input utility program 202 has a predictive input function of presenting candidate character strings in two stages when displaying the candidate character strings for assisting input of a handwritten character string. This predictive input function can be used not only when creating such a handwritten document as shown in FIGS. 7 to 9, but also in all cases including, for example, a case where a keyword for searching is input by handwriting.

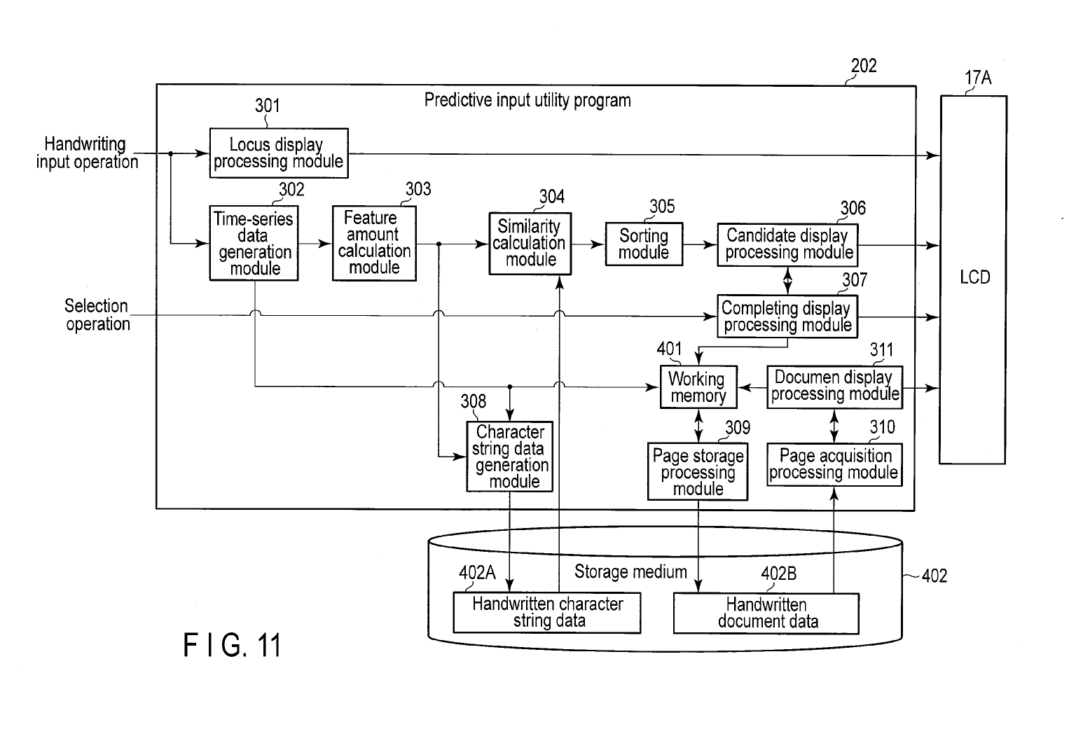

FIG. 11 shows a function configuration example of the predictive input utility program 202. The predictive input utility program 202 uses time-series data (stroke data) input by operating the touch screen display 17, to thereby perform, for example, display of candidate character strings corresponding to a handwritten character string, and overwriting of the handwritten character string with a selected candidate character string.

The predictive input utility program 202 includes a locus display processing module 301, a time-series data generation module 302, a feature amount calculation module 303, a similarity calculation module 304, a sorting module 305, a candidate display processing module 306, a completing display processing module 307, a character string data generation module 308, a page storage processing module 309, a page acquisition processing module 310 and a document display processing module 311.

The touch screen display 17 is configured to detect occurrence of events, such as “touch,” “move (or slide),” “release,” etc. “Touch” is an event indicating that an external object has touched the screen. “Move (or Slide)” is an event indicating that a touch position has moved while the external object is touching the screen. “Release” is an event indicating that the external object is detached from the screen.

The locus display processing module 301 and the time-series data generation module 302 are configured to receive the event “touch,” “move (or slide),” “release,” etc., and thereby detect a handwriting input operation. The “touch” event includes coordinate data indicative of a touch position. The “move (or slide)” event includes coordinate data indicative of a place to which the touch position has moved. The “release” event includes coordinate data indicative of a position away from the screen. Accordingly, the locus display processing module 301 and the time-series data generation module 302 can receive from the touch screen display 17 coordinate sequence data corresponding to the locus of motion of the touch position.

The locus display processing module 301 displays one or more strokes 611, 612 and 613 (hereinafter, also referred to as “the first stroke(s)”) input by handwriting on the screen of the touch screen display 17. More specifically, the locus display processing module 301 receives coordinate sequence data from the touch screen display 17, and displays, on the screen of the LCD 17A of the touch screen display 17, the locus of each stroke made by a handwriting input operation using the stylus 100, based on the coordinate sequence data. Thus, the locus of the stylus 100 while the stylus 100 is kept in contact with the screen, i.e., a stroke, is traced on the screen of the LCD 17A.

The time-series data generation module 302 receives the above-mentioned coordinate sequence data from the touch screen display 17, and generates time-series data (stroke data) having such a structure as described in detail referring to FIG. 3, based on the received coordinate sequence data. In this case, the time-series data, i.e., coordinate data and time-stamp data corresponding to each point on a stroke may be temporarily stored in a working memory 401.

Further, the time-series data generation module 302 outputs the generated time-series data (stroke data) to the feature amount calculation module 303. For instance, the time-series data generation module 302 outputs stroke data corresponding to one stroke to the feature amount calculation module 303 whenever, for example, the one stroke has been input by handwriting.

In the first stage, the feature amount calculation module 303, the similarity calculation module 304, the sorting module 305 and the candidate display processing module 306 display, on the screen one or more candidates for inputting (first-stage candidate character strings) 621 to 624 with excluding the first or second candidate character string, if the first candidate for a plurality of second strokes corresponding to a single character string and the second candidate for a plurality of third strokes corresponding to the same single character string are included in a plurality of candidates for inputting, which correspond to one or more strokes 611, 612 and 613 displayed on the screen by the locus display processing module 301 wherein the plurality of candidates for inputting are included in handwritten character strings among handwritten documents corresponding to handwritten document data 402B stored in a storage medium 402. Further, when one of the first and second candidates 621 and 625 in a plurality of candidates is excluded, the candidate display processing module 306 displays, on the screen, both the first and second candidates 621 and 625 (second-stage candidate character strings) if the other one is selected. For instance, when the first candidate character string 621 has been selected from the first-stage candidate character strings 621 to 624 in the first stage, the candidate display processing module 306 displays, on the screen in the second stage, second-stage candidate character strings including the selected first candidate character string 621, and at least one candidate character string 625 excluded in the first stage because it equals the first candidate character string 621.

The storage medium 402 may store a plurality of handwritten character string data items 402A corresponding to a plurality of handwritten character strings included in a handwritten document. In the first stage, the feature amount calculation module 303, the similarity calculation module 304, the sorting module 305 and the candidate display processing module 306 display, on the screen one or more candidates for inputting (first-stage candidate character strings) 621 to 624 with excluding the first or second candidate character string if the first candidate for a plurality of second strokes corresponding to a single character string and the second candidate for a plurality of third strokes corresponding to the same single character string are included in a plurality of candidates for inputting, which correspond to one or more strokes 611, 612 and 613 displayed on the screen by the locus display processing module 301 wherein the plurality of candidates for inputting are included in handwritten character strings among the plurality of handwritten character string data items 402A corresponding to a plurality of handwritten character strings and stored in the storage medium 402. The handwritten character string data items 402A include a feature amount corresponding to one or more strokes constituting a handwritten character string. The feature amount calculation module 303, the similarity calculation module 304, the sorting module 305 and the candidate display processing module 306 detect, from, for example, the handwritten character strings indicated by the handwritten character string data items 402A, handwritten candidate character strings having feature amounts whose similarity degrees to the feature amount of the one or more first strokes 611, 612 and 613 are higher than a threshold. The feature amount calculation module 303, the similarity calculation module 304, the sorting module 305 and the candidate display processing module 306 display, on the screen in, for example, a descending order of similarity, one or more candidates 621 to 624 obtained by excluding the equivalent candidate from the detected candidates. If one of the first and second candidates 621 and 625 has been excluded from the plurality of candidates, i.e., if the other of the first and second candidates 621 and 625 has been selected, the candidate display processing module 306 displays both the first and second candidates 621 and 625 (second-stage candidate character strings) on the screen. For instance, when the first candidate character string 621 has been selected from the first-stage candidate character strings 621 to 624, the candidate display processing module 306 displays, on the screen in the second stage, second-stage candidate character strings that include the selected first candidate character string 621, and one or more candidate character strings 625 excluded in the first stage because they equal the first candidate character string 621.

More specifically, firstly, the feature amount calculation module 303 calculates a feature amount (first feature amount) using one or more stroke data items corresponding to one or more first strokes 621, 622 and 623 generated by the time-series data generation module 302. The feature amount calculation module 303 calculates the feature amount, based on, for example, the shape of the one or more strokes 621, 622 and 623, or a direction in which the stroke(s) has been handwritten.

Subsequently, the similarity calculation module 304 calculates a degree of similarity for each candidate character string, using the calculated first feature amount and a second feature amount corresponding to each candidate character string in the handwritten character string data items 402A.

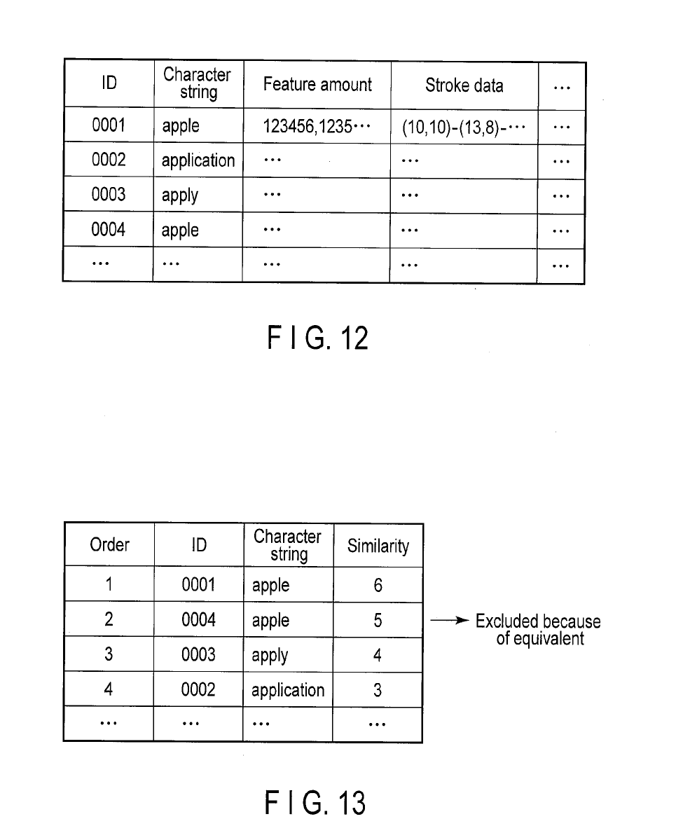

FIG. 12 shows a structure example of the handwritten character string data 402A. The handwritten character string data 402A is generated by analyzing, for example, the stroke data or handwritten document data 402B. Further, the handwritten character string data items 402A are generated for, for example, respective users.

The handwritten character string data 402A includes a plurality of entries corresponding to a plurality of handwritten character strings. More specifically, the handwritten character string data 402A includes a plurality of entries corresponding to a plurality of handwritten character strings associated with a single character string if, for example, the user handwrote the single character string several times in the past. Each handwritten character string corresponds to, for example, a word.

Each entry includes, for example, ID, character string, feature amount and stroke data. In an entry corresponding to a certain handwritten character string, “ID” is identification information assigned to the handwritten character string. “Character string” indicates text (character code string) corresponding to the handwritten character string. “Feature amount” indicates a feature amount corresponding to one or more strokes of the handwritten character string. “Stroke data” indicates stroke data (time-series data) corresponding to one or more strokes of the handwritten character string.

In “Character string,” text (character code string) obtained by, for example, subjecting, to character recognition processing, the stroke data indicated by “Stroke data” is set. Further, in “Feature amount,” a feature amount calculated using, for example, stroke data indicated by “Stroke data,” based on the shape of each stroke or the direction in which each stroke is handwritten, is set.

If, for example, the one or more handwritten first strokes 611, 612 and 613 constitute an arbitrary character string 61 (e.g., a set of characters, such as a word, phrase, etc.), and the input of the character string 61 is halfway (i.e., all strokes of the character string 61 are not yet completed), the similarity calculation module 304 calculates the degrees of similarity of candidate character strings, using the feature amount (first feature amount) corresponding to the one or more first strokes 611, 612 and 613 and the corresponding feature amounts (second feature amounts) of the candidate character strings in the handwritten character string data 402A. The similarity calculation module 304 calculates the degree of similarity of each candidate character string in the handwritten character string data 402A. After that, the sort module 305 sorts the candidate character strings in the handwritten character string data 402A in a descending order of similarity calculated.

FIG. 13 is a view for explaining acquisition, from the handwritten character string data 402A, of candidate character strings sorted based on similarity. It is assumed here that one or more handwritten first strokes 611, 612 and 613 constituting a handwritten character string “ap” 61 are already input.

When the one or more handwritten first strokes 611, 612 and 613 constituting the handwritten character string “ap” 61 are already input, the similarity calculation module 304 calculates, as described above, the degrees of similarity of each candidate character string in the handwritten character string data 402A, with respect to the one or more first strokes 611, 612 and 613 associated with “ap.” For instance, the similarity calculation module 304 calculates the degree of similarity of each candidate character string in the handwritten character string data 402A, using the first feature amount corresponding to the one or more first strokes 611, 612 and 613 associated with “ap,” and the second feature amounts included in the entries of the handwritten character string data 402A. The degree of similarity is represented by, for example, a discrete value based on the degree of similarity between the first feature amount of the one or more first strokes 611, 612 and 613, and the second feature amount of the strokes constituting each candidate character string. A higher value indicates a higher degree of similarity between the first and second feature amounts. The sort module 305 sorts the candidate character strings in the handwritten character string data 402A in a descending order of similarity calculated.

After that, the candidate display processing module 306 excludes equivalent candidate character strings from the sorted candidate character strings to determine the first-stage candidate character strings 621 to 624. In the example of FIG. 13, the candidate display processing module 306 detects that in the candidate character strings, a character string “apple” with an ID of 0001 equals a character string “apple” with an ID of 0004, and excludes, from the first-stage candidate character strings, the character string “apple” with the ID of 0004, which has a lower degree of similarity than the other one. The candidate display processing module 306 displays, on the screen of the LCD 17A, the first-stage candidate character strings 621 to 624 (e.g., a predetermined number of subsequent candidate character strings beginning with the highest degree of similarity) from which the equivalent candidate character strings are excluded.

The candidate display processing module 306 detects that one candidate character string “apple” 621 (hereinafter also referred to as the first candidate character string) has been selected from the first-stage candidate character strings 621 to 624 by a selection operation on the touch screen display 17. Further, the candidate display processing module 306 determines whether there is any candidate character string excluded in the first stage because it equals the selected first candidate character string “apple” 621.

If there is a candidate character string excluded in the first stage because it equals the selected first candidate character string “apple” 621, the candidate display processing module 306 displays, on the screen, second-stage candidate character strings that include the first candidate character string “apple” 621, and the candidate character string “apple” 625 excluded in the first stage because it equals the selected first candidate character string “apple” 621, as was described above referring to FIG. 8.

When one candidate character string “apple” (first candidate character string) 621 has been selected from the displayed second-stage candidate character strings 621 and 625, the completing display processing module 307 replaces the one or more first strokes 611, 612 and 613 (i.e., the stroke(s) constituting a halfway input handwritten character string) with a plurality of second strokes constituting the selected first candidate character string “apple” 621, thereby displaying the second strokes on the screen. The completing display processing module 307 reads, from the handwritten character string data 402A, stroke data corresponding to the selected first candidate character string “apple” 621. After that, the completing display processing module 307 deletes the one or more first strokes 611, 612 and 613 from the screen, and traces the second strokes indicated by the read stroke data, based on the positions in which the one or more first strokes 611, 612 and 613 are traced. Further, the completing display processing module 307 may delete, from the working memory 401, stroke data corresponding to the one or more first strokes 611, 612 and 613, and temporarily store stroke data corresponding to the second strokes in the working memory 401.

Also, when one candidate character string “apple” 625 (hereinafter also referred to as the second candidate character string) has been selected from the displayed second-stage candidate character strings 621 and 625, the completing display processing module 307 replaces the one or more first strokes 611, 612 and 613 (i.e., the stroke(s) constituting a halfway input handwritten character string) with a plurality of third strokes constituting the selected second candidate character string “apple” 625, thereby displaying the third strokes on the screen, as was described above referring to FIG. 9. The completing display processing module 307 reads, from the handwritten character string data 402A, stroke data corresponding to the selected second candidate character string “apple” 625. After that, the completing display processing module 307 deletes the one or more first strokes 611, 612 and 613 from the screen, and traces the third strokes indicated by the read stroke data, based on the positions in which the one or more first strokes 611, 612 and 613 are traced. Further, the completing display processing module 307 may delete, from the working memory 401, stroke data corresponding to the one or more first strokes 611, 612 and 613, and temporarily store stroke data corresponding to the third strokes in the working memory 401.

Yet further, when there is no candidate character string excluded in the first stage because it equals the first candidate character string “apple” 621 (i.e., when a plurality of candidates for inputting corresponding to the one or more first strokes include the first candidate character string “apple” 621, and do not include the second candidate character string 625), the candidate display processing module 306 displays a plurality of candidate character strings 621 to 624 including the first candidate character string “apple” 621. When the first candidate character string “apple” 621 has been selected, the completing display processing module 307 replaces the one or more first strokes 611, 612 and 613 (i.e., the stroke(s) constituting a halfway input handwritten character string) with a plurality of second strokes constituting the first candidate character string “apple” 621, thereby displaying the second strokes on the screen, as was described above referring to FIG. 10. The completing display processing module 307 reads, from the handwritten character string data 402A, stroke data corresponding to the selected first candidate character string “apple” 621. After that, the completing display processing module 307 deletes the one or more first strokes 611, 612 and 613 from the screen, and traces the second strokes indicated by the read stroke data, based on the positions in which the one or more first strokes 611, 612 and 613 are traced. Further, the completing display processing module 307 may delete, from the working memory 401, stroke data corresponding to the one or more first strokes 611, 612 and 613, and temporarily store stroke data corresponding to the second strokes in the working memory 401.

The page storage processing module 309 stores generated stroke data (stroke data temporarily stored in the working memory 401) as handwritten document data 402B in the storage medium 402. The storage medium 402 is, for example, a storage device in the tablet computer 10.

The page acquisition processing module 310 reads desired handwritten document data 402B from the storage medium 402. The read handwritten document data 402B is sent to the document display processing module 311. The document display processing module 311 analyzes the handwritten document data 402B, and displays, on the screen, a document (page) including the locus of each stroke indicated by the stroke data (time-series data).

If none of the displayed candidate character strings has been selected, and if the input of a character string by handwriting has been completed (for example, if all strokes constituting the character string have been handwritten by the user), the character string data generation module 308 generates handwritten character string data 402A (an entry for the handwritten character string data) corresponding to the character string having been input. The character string data generation module 308 may recognize a character (text) corresponding to the one or more strokes by performing character recognition processing based on a feature amount corresponding to the one or more strokes that constitute the character string having been handwritten. The character string data generation module 308 generates an entry for handwritten character string data, which includes the recognized characters (text), the feature amount and stroke data, and adds this entry to the handwritten character string data 402A.

Further, the character string data generation module 308 may generate the handwritten character string data 402A by analyzing already created handwritten document data 402B. For instance, when analyzing handwritten document data 402B written in English, the character string data generation module 308 generates text (text data) corresponding to the handwritten character string by subjecting each character string (stroke data corresponding to each handwritten character string) in the handwritten document to character recognition processing. Subsequently, the character string data generation module 308 detects a word in the generated text, and generates an entry for each word of the handwritten character string data 402A.

Furthermore, when analyzing handwritten document data 402B written in, for example, Japanese, the character string data generation module 308 generates text (text data) corresponding to the handwritten character string by subjecting each character string (stroke data corresponding to each handwritten character string) in the handwritten document to character recognition processing. After that, the character string data generation module 308 subjects the generated text to morphological analysis processing to thereby divide the text into words (morphemes) and generate an entry for each word of the handwritten character string data 402A.

Thus, handwritten character string data 402A can be generated from already created handwritten document data 402B.

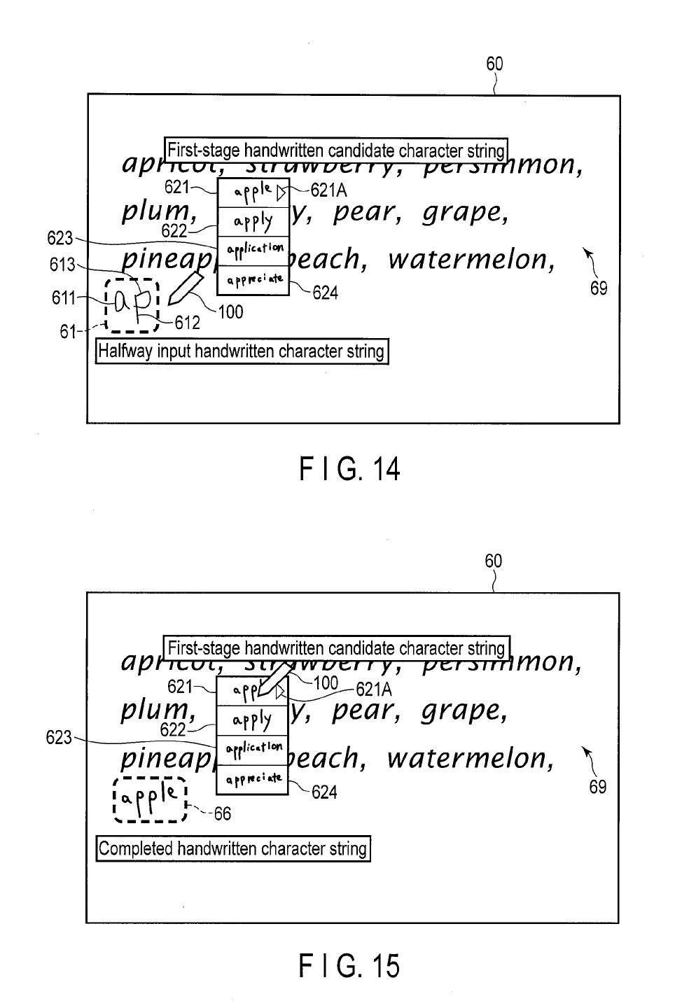

Referring then to FIGS. 14 to 17, a description will be given of another example in which a halfway input handwritten character string is completed, using handwritten candidate character strings displayed in two stages.

As shown in FIG. 14, the screen image 60 of the tablet computer 10 for handwritten documents displays a handwritten character string 69 already input by the user, and strokes 611, 612 and 613 constituting a currently halfway input character string “ap” 61. The feature amount calculation module 303, the similarity calculation module 304, the sorting module 305, and the candidate display processing module 306 display, on the screen image 60, first-stage handwritten candidate character strings 621 to 624 based on the halfway input handwritten character string “ap” 61 (formed of strokes 611, 612 and 613).

More specifically, the feature amount calculation module 303 uses stroke data corresponding to the strokes 611, 612 and 613 constituting the halfway input handwritten character string “ap” 61, to calculate the feature amount (first feature amount) of the character string “ap” 61. The similarity calculation module 304 uses the calculated first feature amount and second feature amounts corresponding to candidate character strings in the handwritten character string data 402A, to calculate the degrees of similarity for the candidate character strings. The sorting module 305 sorts the candidate character strings in the handwritten character string data 402A in a descending order of similarity calculated.

If the sorted candidate character strings include a plurality of handwritten character strings (i.e., equivalent candidate character strings) corresponding to the same character string, the candidate display processing module 306 excludes equivalent candidate character strings by selecting one (e.g., the one having a highest degree of similarity) from the candidate character strings corresponding to the same character string. The candidate display processing module 306 displays, on the image screen 60 in an order based on, for example, similarity, the candidate character strings (first-stage candidate character strings) 621 to 624 from which the equivalent candidate character strings are excluded. If the candidate display processing module 306 has excluded one of the first and second candidate character strings corresponding to the same character string, it further displays a first image associated with the first or second candidate character string that is not excluded. If, for instance, a candidate character string “apple” (second candidate) is excluded because it equals a candidate character string “apple” 621 (first candidate), the candidate display processing module 306 displays a first image (button) 621A associated with the candidate character string “apple” 621 that is not excluded. The first image (button) 621A is displayed in, for example, an area corresponding to the candidate character string “apple” 621. Namely, the candidate display processing module 306 adds the first image (button) 621A to the candidate character string “apple” 621 selected from a plurality of candidate character strings that correspond to the same character string and are included in the displayed first-stage candidate character strings 621 to 624. The first image 621A is used to designate the display of second-stage candidate character strings corresponding to the candidate character string “apple” 621.

As shown in FIG. 15, if the user has selected the candidate character string “apple” 621 (first candidate), the completing display processing module 307 replaces the halfway input handwritten character string 61 with the candidate character string “apple” 621 to thereby trace the completed handwritten character string 66 on the screen image 60. Namely, the completing display processing module 307 replaces the one or more halfway input first strokes 611, 612 and 613 with a plurality of second strokes constituting the candidate character string “apple” 621 to thereby display the second strokes on the screen image 60. The selection of the candidate character string “apple” 621 is performed by, for example, selecting an area in which the strokes of the character string “apple” 621 are traced, or selecting an area, except for the image 621A, in the area corresponding to the character string “apple” 621.

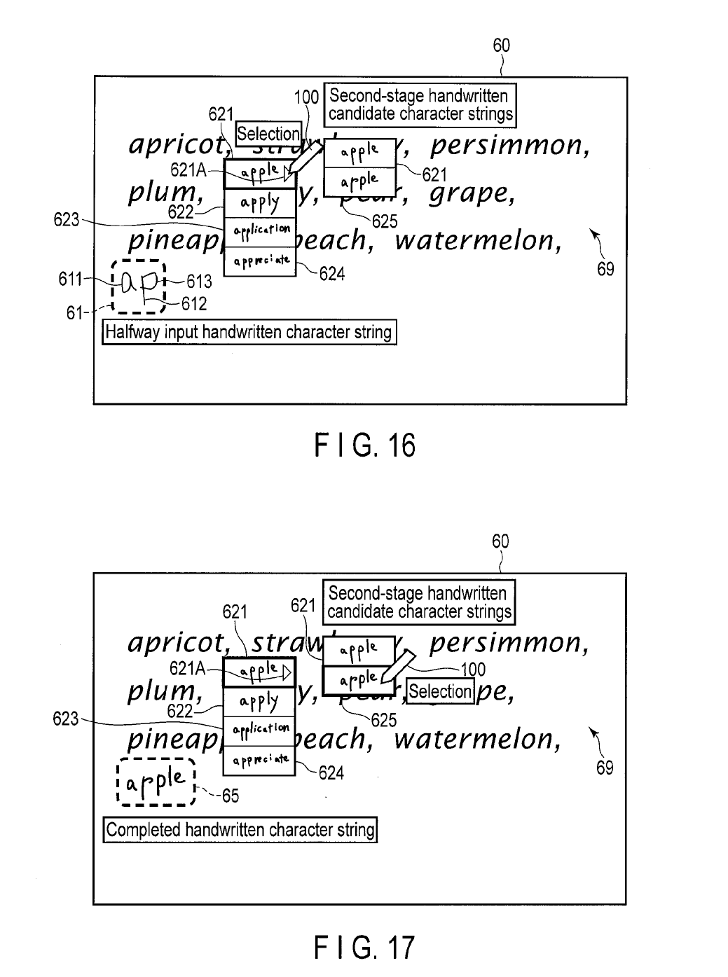

Further, as shown in FIG. 16, if the user has selected an area corresponding to the first image 621A, the candidate display processing module 306 displays, on the screen image 60, second-stage candidate character strings including the candidate character string “apple” 621 (first candidate), and the candidate character string “apple” 625 (second candidate) excluded in the first stage because it equals the candidate character string “apple” 621. Although the candidate character strings 621 and 625 are both character strings of “apple,” they have different shapes (handwriting) depending upon whether, for example, they were handwritten in haste or in a courteous manner in, for example, character strings or documents previously handwritten by the user.

As shown in FIG. 17, if the user has selected a candidate character string 625 (e.g., a most beautiful handwritten candidate character string, a candidate character string suitable for a currently handwritten document, etc.) from the second-stage candidate character strings 621 and 625, the completing display processing module 307 replaces the halfway handwritten character string “ap” 61 with the selected candidate character string 625, thereby tracing a completed handwritten character string “apple” 65 on a handwritten document on the screen image 60. Namely, the completing display processing module 307 displays a plurality of third strokes constituting the candidate character string “apple” 625 on the screen image 60 by replacing the one or more halfway input first strokes 611, 612 and 613 with the third strokes.

By virtue of the above processing, candidates for a character string predicted to be input can be effectively presented.

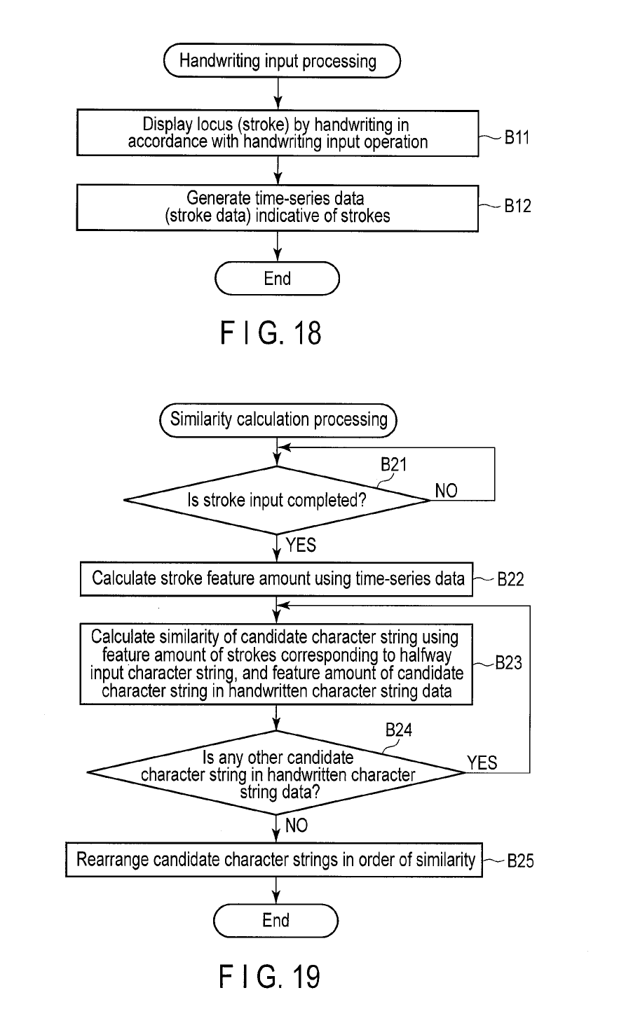

Referring then to the flowchart of FIG. 18, a description will be given of an example of a procedure for handwriting processing performed by the predictive input utility program 202.

The locus display processing module 301 displays on a document the locus (stroke(s)) of motion of, for example, the stylus 100 made by a handwriting input operation (block B11). Further, the time-series data generation module 302 generates the above-mentioned time-series data (stroke data arranged in a time-series order) based on a coordinate sequence corresponding to the locus by the handwriting input operation, and temporarily stores the generated time-series data in the working memory 401 (block B12).

The flowchart of FIG. 19 shows an example of a procedure for similarity calculation processing performed by the predictive input utility program 202.

The feature amount calculation module 303 determines whether input of a handwritten stroke (first stroke) has been completed (block B21). When, for example, having received stroke data corresponding to the first stroke from the time-series data generation module 302, the feature amount calculation module 303 detects that the input of the first stroke has been completed. If the input of the first stroke is not completed (No in block B21), the program returns to block B21, where it is determined again whether the input of the first stroke has been completed.

If the input of the first stroke has been completed (Yes in block B21), the feature amount calculation module 303 calculates a feature amount, using the time-series data (stroke data) corresponding to the first stroke and generated by the time-series data generation module 302 (block B22). The similarity calculation module 304 calculates the degrees of similarity of candidate character strings, using the calculated feature amount (first feature amount) and the respective feature amounts (second feature amounts) corresponding to the candidate character strings in the handwritten character string data 402A (block B23). More specifically, if the first stroke is included in a halfway input character string (character), the similarity calculation module 304 calculates the degrees of similarity of candidate character strings, using a feature amount (first feature amount) including the calculated feature amount and corresponding to one or more handwritten strokes constituting a character in the halfway input character string, and respective feature amounts (second feature amounts) corresponding to the candidate character strings in the handwritten character string data 402A. Further, if the input first stroke is the leading stroke of the character string, the similarity calculation module 304 calculates the degrees of similarity of candidate character strings, using the calculated feature amount (first feature amount), and respective feature amounts (second feature amounts) corresponding to the candidate character strings in the handwritten character string data 402A.

Subsequently, the similarity calculation module 304 determines whether the handwritten character string data 402A includes an entry for any other candidate character string (i.e., an entry for a candidate character string whose similarity is not yet calculated) (block B24). If the handwritten character string data 402A includes an entry for another candidate character string (Yes in block B24), the program returns to block B23, where the similarity of this candidate character string is calculated.

If there is no other candidate character string in the handwritten character string data 402A, i.e., if the degrees of similarity of all candidate character strings have already been calculated (No in block B24), the sorting module 305 rearranges the candidate character strings in a descending order of similarity (block B25).

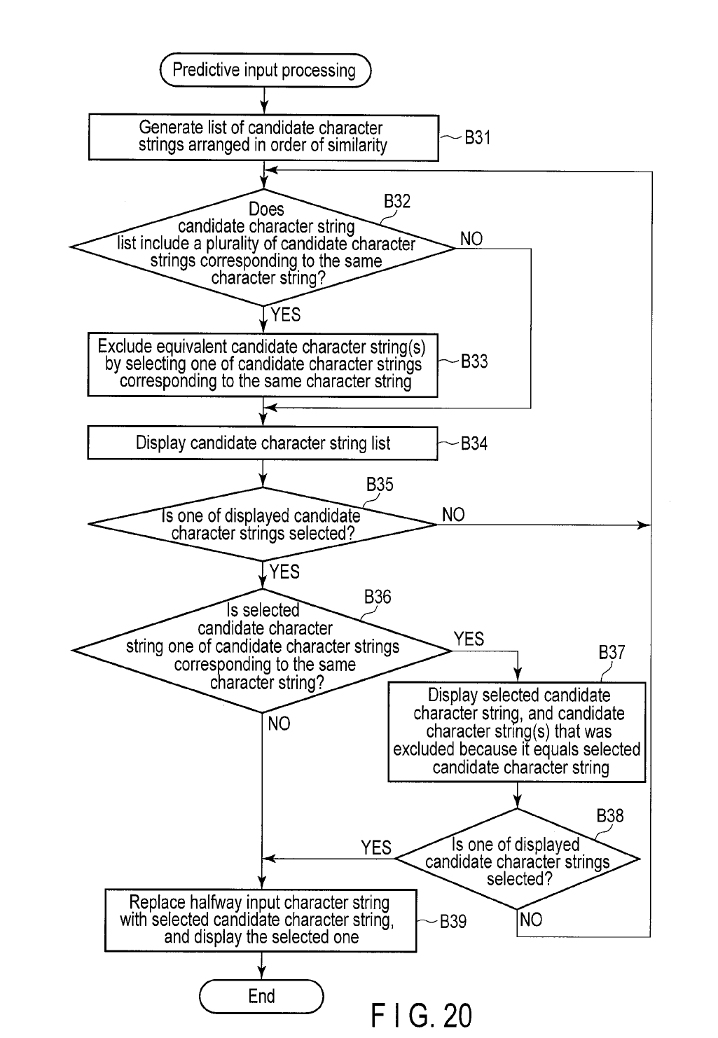

Referring then to the flowchart of FIG. 20, a description will be given of a procedure example of predictive input processing performed by the predictive input utility program 202.

Firstly, the feature amount calculation module 303, the similarity calculation module 304 and the sorting module 305 cooperate to generate a list of candidate character strings arranged in an order of similarity, by the above-described similarity calculation processing of FIG. 19 (block B31). Subsequently, the candidate display processing module 306 determines whether the generated candidate character string list includes a plurality of candidate character strings corresponding to the same character string (block B32). If the list does not include a plurality of candidate character strings for the same character string (No in block B32), the candidate display processing module 306 displays the list of the candidate character strings (block B34).

In contrast, if the list includes a plurality of candidate character strings for the same character string (Yes in block B32), the candidate display processing module 306 selects one of the plurality of candidate character strings corresponding to the same character string to thereby exclude the equivalent candidate character string(s) from the candidate character string list (block B33). After that, the candidate display processing module 306 displays a candidate character string list that includes no equivalent candidate character string (block B34).

Subsequently, the candidate display processing module 306 determines whether one of the displayed candidate character strings has been selected (block B35). If none of the displayed candidate character strings has been selected (No in block B35), the program returns to block B31, where processing for displaying candidate character strings corresponding to a further input handwritten character string (strokes) is performed.

If one of the displayed candidate character strings has been selected (Yes in block B35), the candidate display processing module 306 determines whether the selected candidate character string is a one of the plurality of candidate character strings corresponding to the same character string (block B36). If the selected candidate character string is not one of the plurality of candidate character strings corresponding to the same character string (No in block B36), the completing display processing module 307 replaces the halfway input character string (strokes) with the selected candidate character string to thereby display the selected candidate character string on the screen (block B39).

If the selected candidate character string is one of the plurality of candidate character strings corresponding to the same character string (Yes in block B36), the candidate display processing module 306 displays the selected candidate character string and the candidate character string excluded because it equals the selected candidate character string (block B37). After that, the candidate display processing module 306 determines whether one of the displayed candidate character strings has been selected (block B38). If neither of the displayed candidate character strings has been selected (No in block B38), the program returns to block B31, where processing for displaying candidate character strings corresponding to a further input handwritten character string (strokes) is performed.

In contrast, if one of the displayed candidate character strings has been selected (Yes in block B38), the completing display processing module 307 replaces the halfway input character string (strokes) with the selected candidate character string to thereby display the selected candidate character string on the screen (block B39).

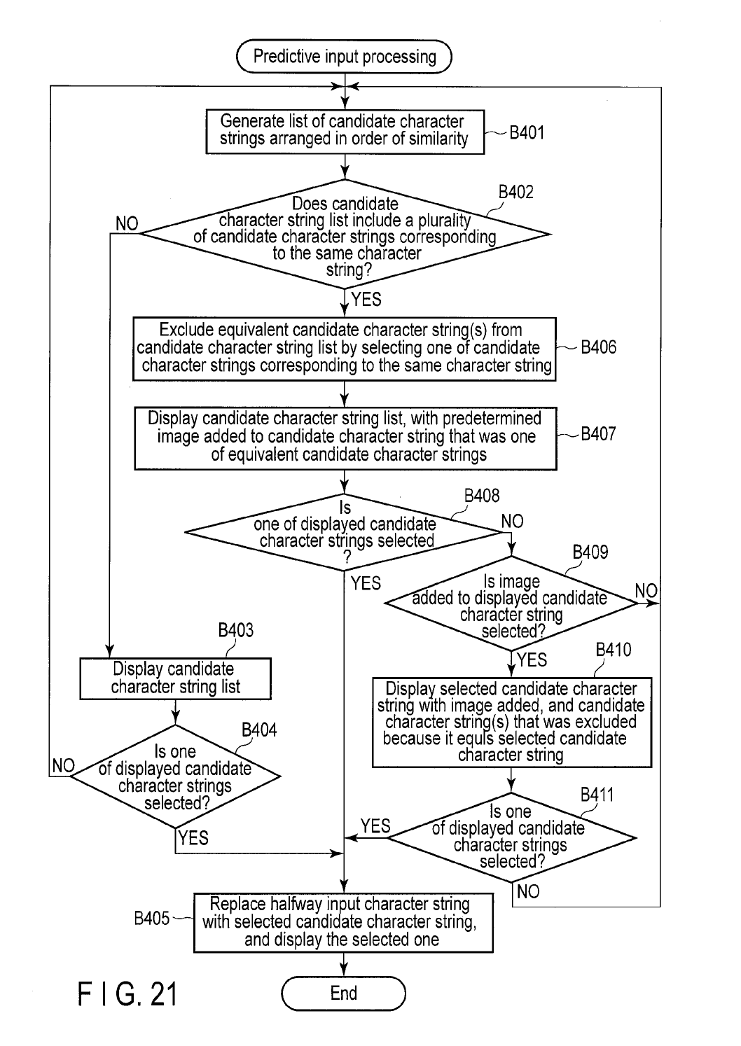

Further, the flowchart of FIG. 21 shows another procedure example of predictive input processing performed by the predictive input utility program 202.

Firstly, the feature amount calculation module 303, the similarity calculation module 304 and the sorting module 305 cooperate to generate a list of candidate character strings arranged in an order of similarity, by the above-described similarity calculation processing of FIG. 19 (block B401). Subsequently, the candidate display processing module 306 determines whether the generated candidate character string list includes a plurality of candidate character strings corresponding to the same character string (block B402). If the list does not include a plurality of candidate character strings for the same character string (No in block B402), the candidate display processing module 306 displays the list of the candidate character strings (block B403).

Subsequently, the candidate display processing module 306 determines whether one of the displayed candidate character strings has been selected (block B404). If none of the displayed candidate character strings has been selected (No in block B404), the program returns to block B401, where processing for displaying candidate character strings corresponding to a further input handwritten character string (strokes) is performed. In contrast, if one of the displayed candidate character strings has been selected (Yes in block B404), the completing display processing module 307 replaces the halfway input character string (strokes) with the selected candidate character string to thereby display the selected candidate character string on the screen (block B405).

Further, if the candidate character string list includes a plurality of candidate character strings corresponding to the same character string (Yes in block B402), the candidate display processing module 306 excludes an equivalent candidate character string (or equivalent candidate character strings) from the list by selecting one of the candidate character strings corresponding to the same character string (block B406). The candidate display processing module 306 displays the candidate character string list, with a predetermined image added to the candidate character string that was included in the equivalent candidate character strings (block B407). In the displayed candidate character string list, the plurality of candidate character strings are arranged, for example, in a predetermined direction, with the predetermined image added to the candidate character string that was included in the equivalent candidate character strings.

Subsequently, the candidate display processing module 306 determines whether one of the displayed candidate character strings has been selected (block B408). If one of the displayed candidate character strings has been selected (Yes in block B408), the completing display processing module 307 replaces the halfway input character string (strokes) with the selected candidate character string to thereby display the selected candidate character string on the screen (block B405).

In contrast, if none of the displayed candidate character strings has been selected (No in block B408), the candidate display processing module 306 determines whether the image added to the candidate character string has been selected (block B409). If the image added to the candidate character string is not selected (No in block B409), the program returns to block B401, where processing for displaying candidate character strings corresponding to a further input handwritten character string (strokes) is performed.

If the image added to the candidate character string has been selected (Yes in block B409), the candidate display processing module 306 displays the candidate character string with the selected image, and the candidate character string(s) that was excluded because it equals the candidate character string with the image (block B410). After that, the candidate display processing module 306 determines whether one of the displayed candidate character strings has been selected (block B411). If one of the displayed candidate character strings has been selected (Yes in block B411), the completing display processing module 307 replaces the halfway input character string (strokes) with the selected candidate character string to thereby display the selected candidate character string on the screen (block B405). If one of the displayed candidate character strings is not selected (No in block B411), the program returns to block B401.

As described above, the embodiment can effectively provide candidates for a character string predicted to be input. The locus display processing module 301 displays one or more first strokes input by handwriting on the screen of the touch screen display 17. If a plurality of candidates for inputting corresponding to one or more first strokes include first candidates for a plurality of second strokes corresponding to the same character string, and second candidates for a plurality of third strokes corresponding to the same character string, the candidate display processing module 306 excludes the first or second candidates to display one or more candidates on the screen of the LCD 17A.

When candidate character strings corresponding to a halfway input handwritten character string are displayed utilizing a history of user handwriting inputs, candidate character strings as the equivalent character strings may be displayed, which may reduce the possibility of display of user expected candidate character strings. However, in the embodiment, by virtue of the above-described structure, candidate character strings excluding equivalent candidate character strings are displayed. This enhances the possibility of display of user expected candidate character strings, and enables the user to easily select, from the displayed candidate character strings, a character string they wish to input.

Further, when one of the first and second candidates has been excluded, i.e., when the other of the first and second candidates has been selected, the candidate display processing module 306 displays both the first and second candidates on the screen. As a result, candidates corresponding to the same character string but having different shapes (handwriting) are displayed. This means that a halfway input character string (strokes) can be completed by a character string of a shape more agreeable to the user (e.g., a more beautiful shape).

The processing procedures of the embodiment described above referring to the flowcharts of FIGS. 18 to 21 can be realized by software. Accordingly, the same advantages as those of the embodiment can be easily achieved simply by installing a program for executing the processing procedures into a computer through a computer-readable storage medium storing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a processing circuitry to display one or more first strokes input by handwriting on a screen, and to display input candidates searched by using the one or more first strokes after an input of the one or more first strokes,
wherein if a first candidate comprising second strokes and a second candidate comprising third strokes corresponding to a same character string are searched as input candidates by using the one or more first strokes, one of the first candidate and the second candidate is excluded from input candidates, and the other of the first candidate and the second candidate is displayed as an input candidate on the screen.

2. The electronic device of claim 1, wherein if one of the first and second candidates is excluded from input candidates, the processing circuitry displays at least one of the first candidate and the second candidate on the screen in response to selection of the other of the first candidate and the second candidate.

3. The electronic device of claim 2, wherein
the processing circuitry replaces the one or more first strokes with the second strokes to display on the screen if the first candidate is selected after the first and second candidates are displayed, and the processing circuitry replaces the one or more first strokes with the third strokes to display on the screen if the second candidate is selected.

4. The electronic device of claim 1, wherein
the processing circuitry displays the input candidates on the screen if the input candidates includes the first candidate and does not include the second candidate,
the processing circuitry replaces the one or more first strokes with the second strokes to display on the screen in response to selection of the first candidate.

5. The electronic device of claim 1, wherein the processing circuitry further displays a first image associated with the other of the first and second candidates if one of the first and second candidates is excluded.

6. The electronic device of claim 5, wherein
the processing circuitry displays the first and second candidates on the screen if the first image is selected,
the processing circuitry replaces the one or more first strokes with the second strokes to display on the screen if the first candidate is selected, and
the processing circuitry replaces the one or more first strokes with the third strokes to display on the screen if the second candidate is selected.

7. A method comprising:
displaying one or more first strokes input by handwriting on a screen; and
displaying input candidates searched by using the one or more first strokes after an input of the one or more first strokes,
wherein if a first candidate comprising second strokes and a second candidate comprising third strokes corresponding to a same character string are searched as input candidates by using the one or more first strokes, one of the first candidate and the second candidate is excluded from input candidates, and the other of the first candidate and the second candidate is displayed as an input candidate on the screen.

8. The method of claim 7, further comprising, if one of the first and second candidates is excluded from input candidates, displaying at least one of the first candidate and the second candidate on the screen in response to selection of the other of the first candidate and the second candidate.

9. The method of claim 8, further comprising:
replacing the one or more first strokes with the second strokes to display on the screen if the first candidate is selected after the first and second candidates are displayed; and
replacing the one or more first strokes with the third strokes to display on the screen if the second candidate is selected.

10. The method of claim 7, further comprising:
displaying the input candidates on the screen if the input candidates includes the first candidate and does not include the second candidate; and
replacing the one or more first strokes with the second strokes to display on the screen in response to selection of the first candidate.

11. The method of claim 7, further comprising:
displaying a first image associated with the other of the first and second candidates if one of the first and second candidates is excluded.

12. The method of claim 11, further comprising:
displaying the first and second candidates on the screen if the first image is selected;
replacing the one or more first strokes with the second strokes to display on the screen if the first candidate is selected; and
replacing the one or more first strokes with the third strokes to display on the screen if the second candidate is selected.

13. A non-transitory computer readable medium having stored thereon a computer program which is executable by a computer, the computer program controlling the computer to execute functions of:
displaying one or more first strokes input by handwriting on a screen; and
displaying input candidates searched by using the one or more first strokes after an input of the one or more first strokes,
wherein if a first candidate comprising second strokes and a second candidate comprising third strokes corresponding to a same character string are searched as input candidates by using the one or more first strokes, one of the first candidate and the second candidate is excluded from input candidates, and the other of the first candidate and the second candidate is displayed as an input candidate on the screen.

14. The non-transitory computer readable medium of claim 13, further comprising, if one of the first and second candidates is excluded from input candidates, displaying at least one of the first candidate and the second candidate on the screen in response to selection of the other of the first candidate and the second candidate.

15. The non-transitory computer readable medium of claim 14, further comprising:
replacing the one or more first strokes with the second strokes to display on the screen if the first candidate is selected after the first and second candidates are displayed; and
replacing the one or more first strokes with the third strokes to display on the screen if the second candidate is selected.

16. The non-transitory computer readable medium of claim 13, further comprising:
displaying the input candidates on the screen if the input candidates includes the first candidate and does not include the second candidate; and
replacing the one or more first strokes with the second strokes to display on the screen in response to selection of the first candidate.

17. The non-transitory computer readable medium of claim 13, further comprising:
displaying a first image associated with the other of the first and second candidates if one of the first and second candidates is excluded.

18. The non-transitory computer readable medium of claim 17, further comprising:
displaying the first and second candidates on the screen if the first image is selected;
replacing the one or more first strokes with the second strokes to display on the screen if the first candidate is selected; and
replacing the one or more first strokes with the third strokes to display on the screen if the second candidate is selected.
